(19) United States
(12) Patent Application Publication
(10) Pub. No.: US 2023/0143934 A1
(43) Pub. Date: May 11, 2023

(54) SELECTIVE VIDEO ANALYTICS BASED ON CAPTURE LOCATION OF VIDEO

(71) Applicant: Honeywell International Inc., Charlotte, NC (US)

(72) Inventor: Manjunatha Tumkur Divakara, Tumkur (IN)

(21) Appl. No.: 17/523,497

(22) Filed: Nov. 10, 2021

(51) Int. Cl. H04N 7/18; G06K 9/00

(52) U.S. Cl. CPC H04N 7/185; G06K 9/00778; G06K 2209/23; G06K 2209/15; G06K 9/00221; G01S 19/42

(57) ABSTRACT

A mobile security device such as a drone includes a video camera, a memory that is configured to store a plurality of video analytics algorithms, a position sensor, a transceiver and a controller. The controller is configured to determine a position of the mobile security device based on information provided by the position sensor and to select one or more video analytics algorithms of the plurality of video analytics algorithms based at least in part upon the determined position of the mobile security device. The controller is configured to instruct the video camera to capture video and to perform the selected one or more video analytics algorithms on the captured video, resulting in one or more video analytics results. The controller is configured to transmit one or more of the video analytics results to a remote device via the transceiver.

### TECHNICAL FIELD

The present disclosure pertains generally to mobile security devices that carry video cameras and more particularly to methods and systems for performing video analytics on video captured by such mobile security devices.

### BACKGROUND

Mobile devices such as but not limited to drones, smart phones, tablets, and other mobile devices, often carry video cameras that can capture video of a scene. Some mobile devices include a controller that can perform some level of video analytics on the captured video. Mobile devices can often travel in a variety of different environments. For example, a drone can fly in both indoor and outdoor environments, and depending on the current task assigned to the drone, the drone may be looking for different types of security incidences. A need remains for improved methods and systems for performing suitable video analytics on video captured by mobile security devices.

### SUMMARY

This disclosure generally to mobile security devices that carry video cameras and more particularly to mobile security devices that carry video cameras and perform video analytics, where the video analytics that are performed are based at least in part on a location of the mobile security device when the video was captured. An example is found in a drone. An illustrative drone includes a video camera that is carried by the drone, a memory that is configured to store a plurality of video analytics algorithms, a position sensor, a transceiver and a controller that is operably coupled to the video camera, the memory, the position sensor and the transceiver. The controller is configured to determine a position of the drone based on information provided by the position sensor and to select one or more video analytics algorithms of the plurality of video analytics algorithms based at least in part upon the determined position of the drone. The controller is configured to instruct the video camera to capture video and to perform the selected one or more video analytics algorithms on the captured video, resulting in one or more video analytics results. In some cases, the controller is configured to transmit one or more of the video analytics results to a remote device via the transceiver.

Another example is found in a surveillance system that includes a mobile security device. The mobile security device includes a video camera that is carried by the mobile security device, a memory that is configured to store a plurality of video analytics algorithms, a position sensor, a transceiver and a controller that is operably coupled to the video camera, the memory, the position sensor and the transceiver. The controller is configured to instruct the video camera to capture video and save the captured video to the memory. The controller is configured to determine a position of the mobile security device, based on information provided by the position sensor, at a time that is representative of when the video camera captured the video, and to transmit at least part of the captured video saved in the memory along with the corresponding position.

In some instances, the surveillance system also includes a remote device. The remote device includes a memory that is configured to store a plurality of video analytics algorithms, a transceiver, and a controller that is operably coupled to the memory and the transceiver of the remote device. In some cases, the controller of the remote device is configured to receive the at least part of the captured video and the corresponding position transmitted by the mobile security device and to select one or more video analytics algorithms of the plurality of video analytics algorithms based at least in part upon the received position of the mobile security device. In some cases, the controller of the remote device is configured to perform the selected one or more video analytics algorithms on the received captured video, resulting in one or more video analytics results, and to store the one or more video analytics results.

Another example is found in a method of performing video surveillance. A video is captured from a location, and a location indicator representative of the location is stored. One or more video analytics algorithms of a plurality of video analytics algorithms are selected based at least in part on the location indicator. The selected one or more video analytics algorithms are performed on the captured video, resulting in one or more results. At least some of the one or more results are displayed on a display.

The preceding summary is provided to facilitate an understanding of some of the features of the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following description of various illustrative embodiments of the disclosure in connection with the accompanying drawings, in which:

FIG. 1 is a schematic block diagram of an illustrative mobile device;

FIG. 2 is a schematic block diagram of an illustrative surveillance system; and

FIG. 3 is a flow diagram showing an illustrative method.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DESCRIPTION

The following description should be read with reference to the drawings wherein like reference numerals indicate like elements. The drawings, which are not necessarily to scale, are not intended to limit the scope of the disclosure. In some of the figures, elements not believed necessary to an understanding of relationships among illustrated components may have been omitted for clarity.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

Mobile security devices can be used for surveillance in a variety of different circumstances, both indoors and outdoors. While drones are used as a primary example, the present disclosure is applicable to other forms of mobile security devices including smart phones, tablets and/or any other suitable mobile device with a video camera. For indoors use, drones can be used in any large facility to provide a video camera anywhere that a video camera is desired. Drones can have standard patrol patterns, for example, although if there is an incident or suspected incident within a particular location that does not have fixed video cameras, or has limited video camera coverage, additional drones can be instructed to proceed to the particular location in order to provide additional video coverage of the incident. The drones may be instructed to proceed to the particular location by a centralized security system controller, for example, or the drones may communicate with each other and may independently decide where they should fly.

Indoor facilities that can accommodate drones include but are not limited to large facilities such as airport terminals, airplane hangers, manufacturing facilities, parking garages, shopping malls, sporting facilities and the like. For outdoor use, drones can be used to patrol or provide additional video capability to parking lots and traffic surveillance for roadways, amusement parks, and the like. Drones can also be used outdoors in a temporary fashion, to provide video surveillance capability for temporary events such as parades, demonstrations and protests, for example.

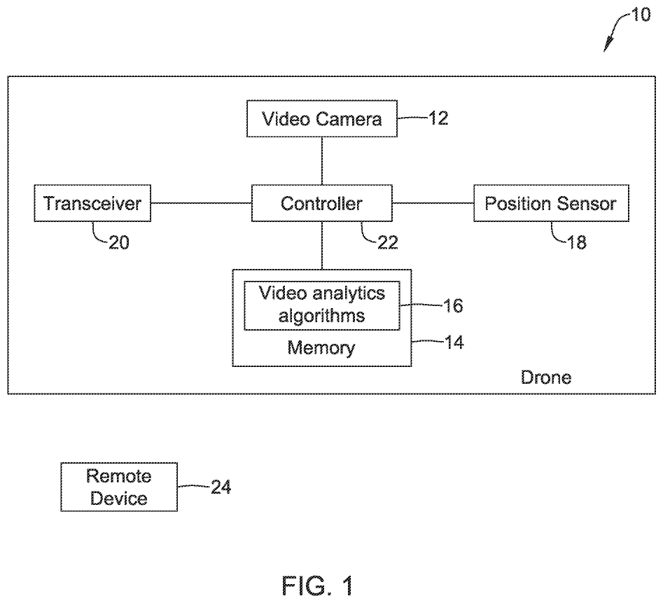

FIG. 1 is a schematic block diagram of a mobile security device 10 that may be considered as being configured for either indoor use or outdoor use. In some cases, the mobile security device 10 may be a drone. The illustrative mobile security device 10 includes a video camera 12 that is carried by the mobile security device 10. A memory 14 is configured to store a plurality of video analytics algorithms 16. As will be discussed, one or more video analytics algorithms 16 may be selected for execution, depending on where the mobile security device 10 is at a particular time. The video analytics algorithms 16 include two or more different video analytics algorithms. Example video analytics algorithms can include, but are not limited to, a people count video analytics algorithm, a crowd detection video analytics algorithm, a loitering detection video analytics algorithm, an intrusion detection video analytics algorithm, a queue length video analytics algorithm, an unidentified object detection video analytics algorithm, an occupancy detection video analytics algorithm, a vehicle detection video analytics algorithm, a vehicle count video analytics algorithm and a license plate detection video analytics algorithm. These are just examples.

The illustrative mobile security device 10 includes a position sensor 18, a transceiver 20 and a controller 22 that is operably coupled to the video camera 12, the memory 14, the position sensor 18 and the transceiver 20. The controller 22 is configured to determine a position of the mobile security device 10 based on information provided by the position sensor 18 and to select one or more video analytics algorithms of the plurality of video analytics algorithms 16 based at least in part upon the determined position of the mobile security device 10.

In some cases, when a single video analytics algorithm is selected based on the position of the mobile security device 10, Table 1 below provide an example correlation between a position or region in a monitored area and a corresponding video analytics algorithm. In Table 1, each position 1, 2, 3, 4, and 5 corresponds to predefined set of coordinates ((x, y, z), (x+δx, y+δy, z+δz)) in the monitored area. When a video is captured by the mobile security device 10 when the position of the mobile security device 10 falls within one of these sets of coordinates, the corresponding video analytics algorithm is selected and applied to the captured video.

TABLE 1

| Position | Video Analytics Algorithm Desired |
|---|---|
| 1 | People count algorithm |
| 2 | Loitering detection algorithm |
| 3 | Intrusion detection algorithm |
| 4 | Occupancy detection algorithm |
| 5 | Vehicle count algorithm |

In Table 1, when the mobile security device 10 falls within the predefined set of coordinates that correspond to position 1, a people count video analytics algorithm is selected. When the mobile security device 10 falls within the predefined set of coordinates that correspond to position 2, a loitering detection video analytics algorithm is selected. When the mobile security device 10 falls within the predefined set of coordinates that correspond to position 3, an intrusion detection video analytics algorithm is selected. When the mobile security device 10 falls within the predefined set of coordinates that correspond to position 4, an occupancy detection video analytics algorithm is selected. When the mobile security device 10 falls within the predefined set of coordinates that correspond to position 5, vehicle count video analytics algorithm is selected.

In some cases, there may be a desire to perform two or more different video analytics algorithms, depending on the position of the mobile security device 10. Table 2 below provides an example of various positions for which performing two or more different video analytics algorithms is desired.

TABLE 2

| | People | Loitering | Intrusion | Occupancy | Vehicle |
|---|---|---|---|---|---|
| Position | count | Detection | detection | Detection | count |
| 1 | Yes | Yes | No | Yes | No |
| 2 | No | Yes | No | No | No |
| 3 | Yes | No | Yes | No | No |
| 4 | No | Yes | No | No | No |
| 5 | Yes | No | No | Yes | Yes |

In some cases, selecting one or more video analytics algorithms may include selecting a single video analytics algorithm out of the plurality of video analytics algorithms 16. In some instances, selecting one or more video analytics algorithms may include selecting two or more different video analytics algorithms out of the plurality of video analytics algorithms 16. In the example shown in FIG. 1, the controller 22 is configured to instruct the video camera 12 to capture video. In some cases, the controller 22 is also configured to perform the selected one or more video analytics algorithms on the captured video depending on the current position of the mobile security device 10, resulting in one or more video analytics results. This may include performing one video analytics algorithm, if only one video analytics algorithm was selected. This may include performing two or more video analytics algorithms, either sequentially or simultaneously, if two or more different video analytics algorithms were selected. In some instances, the controller 22 may simply record the location of the mobile security device 10 when the video was captures, and then send the video and the recorded location to a remote device 24, and the remote device 24 selects and performs the video analytics algorithm that correspond to the recorded location. In some cases, the controller 22 may perform one or more video analytics algorithms (e.g. less computationally intensive video analytics algorithms) that correspond to the recorded location, and the remote device may perform additional video analytics algorithms (e.g. more computationally intensive video analytics algorithms) that correspond to the recorded location. In some cases, some video analytics algorithms may be performed on the edge, such as by the controller 22 of the mobile security device 10, and some video analytics algorithms may be performed on the cloud, such as by the remote device 24. These are just examples.

When the controller 22 performs some video analytics algorithms, the controller 22 is configured to transmit one or more of the video analytics results to remote device 24 via the transceiver 20. In some cases, the remote device 24 may be a desktop computer or a cloud-based server. The remote device 24 may be part of a surveillance system control device, for example.

In some cases, the position sensor 18 may be configured to enable the controller 22 to ascertain an indoor position via triangulation. For example, the position sensor 18 may be configured to be able to triangulate between multiple beacons that are disposed within an indoors facility. The position sensor 18 may be configured to use a 5G cellular network to ascertain its position (either indoors or outdoors). In some cases, the position sensor 18 may be configured to triangulate its position using a magnetometer, ultrawide band (UWB) or even BLE (Bluetooth low energy). The position sensor 18 may have access to a floorplan of a facility by communicating with a BIM (building information model) or even a BMS (building management system). For outdoor locations, GPS (global positioning system), triangularization and/or other suitable technique may be used to ascertain position.

In this, position may refer strictly to the physical location of the mobile security device 10. For example, the position of the mobile security device 10 is 5 meters due south of door #14 within the facility. In some cases, position may also take into account the field of view of the video camera 12 of the mobile security device 10. While the mobile security device 10 may currently be 5 meters due south of door #14 within the facility, the video camera 12 may have a field of view that extends westward down hallway #4. In some cases, position can be a combination of physical location and field of view.

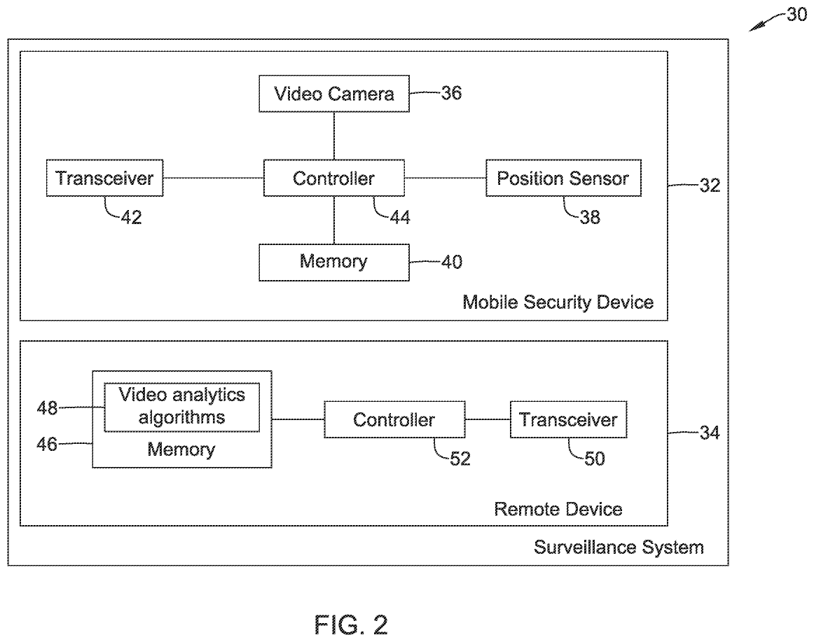

FIG. 2 is a schematic block diagram of an illustrative surveillance system 30. The illustrative surveillance system 30 includes a mobile security device 32. In some cases, the surveillance system 30 also includes a remote device 34. In some cases, the remote device 34 may be a desktop computer or a cloud-based server.

The mobile security device 32, which may be configured to fly, includes a video camera 36, a position sensor 38, a memory 40, a transceiver 42 and a controller 44 that is operably coupled to the video camera 36, the position sensor 38, the memory 40 and the transceiver 42. The controller 44 is configured to instruct the video camera 36 to capture video and save the captured video to the memory 40. The controller 44 is configured to determine a position of the mobile security device 32, based on information provided by the position sensor 38, at a time that is representative of when the video camera 36 captured the video. The controller 44 is configured to transmit at least part of the captured video saved in the memory 40 along with the corresponding position.

In some cases, the mobile security device 32 is configured to be carried or even fly indoors, and the position sensor 38 is configured to enable the controller 44 to ascertain its indoors position via triangulation. For example, the position sensor 38 may be configured to be able to triangulate between multiple beacons that are disposed within an indoors facility. The position sensor 38 may be configured to use a 5G cellular network to ascertain its position. In some cases, the position sensor 18 may be configured to triangulate its position using a magnetometer, ultrawide band (UWB) or even BLE (Bluetooth low energy). The position sensor 38 may have access to a floorplan of the facility by communicating with a BIM (building information model) or even a BMS (building management system). For a mobile security device 32 that is configured to fly outdoors, GPS (global positioning system) may be used to ascertain position.

In this, position may refer strictly to the physical location of the mobile security device 32. For example, the position of the mobile security device 32 is 14 meters due north of door #6 within the facility. In some cases, position may also take into account the field of view of the video camera 36. While the mobile security device 32 may currently be 14 meters due north of door #6 within the facility, the video camera 36 may have a field of view that extends into the lobby. In some cases, position can be a combination of physical location and field of view.

In the example shown, the remote device 34 includes a memory 46 that is configured to store a plurality of video analytics algorithms 48. The illustrative remote device 34 includes a transceiver 50 and a controller 52 that is operably coupled with the memory 46 and the transceiver 50. The video analytics algorithms 48 include a number of different video analytics algorithms. The video analytics algorithms may including but are not limited to a people count video analytics algorithm, a crowd detection video analytics algorithm, a loitering detection video analytics algorithm, an intrusion detection video analytics algorithm, a queue length video analytics algorithm, an unidentified object detection video analytics algorithm, an occupancy detection video analytics algorithm, a vehicle detection video analytics algorithm, a vehicle count video analytics algorithm and a license plate detection video analytics algorithm. These are just examples.

The controller 52 of the remote device 34 is configured to receive the at least part of the captured video and the corresponding position transmitted by the mobile security device 32. The controller 52 of the remote device 34 is configured to select one or more video analytics algorithms of the plurality of video analytics algorithms 48 based at least in part upon the received position of the mobile security device 32 and to perform the selected one or more video analytics algorithms on the received captured video, resulting in one or more video analytics results. The controller 52 of the remote device 34 is configured to store the one or more video analytics results.

In some cases, selecting one or more video analytics algorithms includes selecting a single video analytics algorithm out of the plurality of video analytics algorithms 48. In some cases, the remote device 34 is a remote server, and the plurality of video analytics algorithms 48 include one or more of a face detection video analytics algorithm, a facial recognition video analytics algorithm, a mask detection video analytics algorithm, and a walking gate video analytics algorithm.

In some instances, the controller 44 of the mobile security device 32 is configured to select one or more mobile security device video analytics algorithms of a plurality of mobile security device video analytics algorithms based at least in part upon the position of the mobile security device 32. The controller 44 of the remote device 34 may be configured to perform the selected one or more mobile security device video analytics algorithms on the captured video, resulting in one or more video analytics results, and to transmit one or more of the video analytics results to the remote device 34.

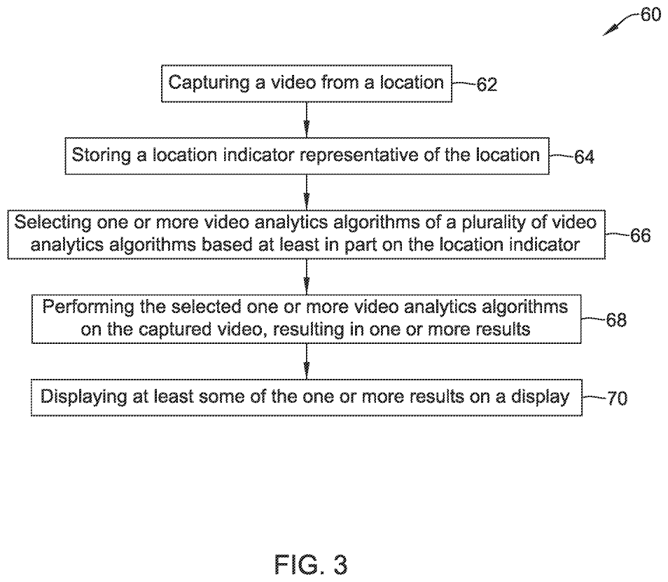

FIG. 3 is a flow diagram showing an illustrative method 60 of performing video surveillance. A video is captured from a location, as indicated at block 62. A location indicator representative of the location is stored, as indicated at block 64. One or more video analytics algorithms of a plurality of video analytics algorithms are selected based at least in part on the location indicator, as indicated at block 66. The selected one or more video analytics algorithms are performed on the captured video, resulting in one or more results, as indicated at block 68. At least some of the one or more results are saved and/or displayed on a display, as indicated at block 70.

In some cases, the video is captured by a mobile security device, and at least some of the selected one or more video analytics algorithms are performed by the mobile security device. In some instances, the video is captured by a mobile security device, and the mobile security device is configured to transmit at least part of the captured video and the location indicator to a remote device, and at least some of the selected one or more video analytics algorithms are performed by the remote device.

Those skilled in the art will recognize that the present disclosure may be manifested in a variety of forms other than the specific embodiments described and contemplated herein. Accordingly, departure in form and detail may be made without departing from the scope and spirit of the present disclosure as described in the appended claims.

1. A drone, comprising:
a video camera carried by the drone;
a memory storing a plurality of available video analytics algorithms;
a position sensor;
a transceiver;
a controller operably coupled to the video camera, the memory, the position sensor and the transceiver, the controller configured to:
determine a position of the drone based on information provided by the position sensor;
select one or more video analytics algorithms from the plurality of available video analytics algorithms based at least in part upon the determined position of the drone, wherein the selected one or more video analytics algorithms include less than all of the plurality of available video analytics algorithms;
instruct the video camera to capture video;
perform the selected one or more video analytics algorithms on the captured video, resulting in one or more video analytics results; and
transmit one or more of the video analytics results to a remote device via the transceiver.

2. The drone of claim 1, wherein selecting one or more video analytics algorithms comprises selecting a single video analytics algorithm out of the plurality of available video analytics algorithms.

3. The drone of claim 1, wherein:
selecting one or more video analytics algorithms comprises selecting two or more different video analytics algorithms out of the plurality of available video analytics algorithms; and
performing the selected two or more video analytics algorithms on the captured video.

4. The drone of claim 1, wherein the plurality of available video analytics algorithms comprise two or more of:
a people count video analytics algorithm;
a crowd detection video analytics algorithm;
a loitering detection video analytics algorithm;
an intrusion detection video analytics algorithm;
a queue length video analytics algorithm;
an unidentified object detection video analytics algorithm;
an occupancy detection video analytics algorithm;
a vehicle detection video analytics algorithm;
a vehicle count video analytics algorithm; and
a license plate detection video analytics algorithm.

5. The drone of claim 1, wherein the drone is configured to fly indoors, and the position sensor is configured to enable the controller to ascertain its indoors position via triangulation.

6. The drone of claim 1, wherein the drone is configured to fly outdoors, and the position sensor is configured to enable the controller to ascertain its outdoors position via GPS.

7. The drone of claim 1, wherein the position of the drone at least partially defines a physical location of the drone.

8. The drone of claim 1, wherein the position of the drone at least partially defines a field of view of the video camera carried by the drone.

9. A surveillance system comprising:
a mobile security device including:
a video camera carried by the mobile security device;
a memory;
a position sensor;
a transceiver;
a controller operably coupled to the video camera, the memory, the position sensor and the transceiver, the controller configured to:
instruct the video camera to capture video and save the captured video to the memory;
determine a position of the mobile security device, based on information provided by the position sensor, at a time that is representative of when the video camera captured the video;
transmit at least part of the captured video saved in the memory along with the corresponding position
a remote device including:
a memory configured to store a plurality of available video analytics algorithms;
a transceiver;
a controller operably coupled to the memory and the transceiver of the remote device, the controller of the remote device is configured to:
receive the at least part of the captured video and the corresponding position transmitted by the mobile security device;
select one or more video analytics algorithms from the plurality of available video analytics algorithms based at least in part upon the received position of the mobile security device, wherein the selected one or more video analytics algorithms include less than all of the plurality of available video analytics algorithms;
perform the selected one or more video analytics algorithms on the received captured video, resulting in one or more video analytics results; and
store the one or more video analytics results.

10. The surveillance system of claim 9, wherein the mobile security device is configured to fly indoors, and the position sensor is configured to enable the controller to ascertain its indoors position via triangulation.

11. The surveillance system of claim 9, wherein the mobile security device is configured to fly outdoors, and the position sensor is configured to enable the controller to ascertain its outdoors position via GPS.

12. The surveillance system of claim 9, wherein the position of the mobile security device at least partially defines a physical location of the mobile security device.

13. The surveillance system of claim 9, wherein the position of the mobile security device at least partially defines a field of view of the video camera carried by the mobile security device.

14. (canceled)

15. The surveillance system of claim 9, wherein selecting one or more video analytics algorithms comprises selecting a single video analytics algorithm out of the plurality of available video analytics algorithms.

16. The surveillance system of claim 9, wherein the remote device is a remote server, and the plurality of available video analytics algorithms comprise one or more of:
a face detection video analytics algorithm;
a facial recognition video analytics algorithm;
a mask detection video analytics algorithm; and
a walking gate video analytics algorithm.

17. The surveillance system of claim 9, wherein the controller of the mobile security device is further configured to:
select one or more mobile security device video analytics algorithms from a plurality of available mobile security device video analytics algorithms based at least in part upon the position of the mobile security device, wherein the selected one or more mobile security device video analytics algorithms include less than all of the plurality of available mobile security device video analytics algorithms;
perform the selected one or more mobile security device video analytics algorithms on the captured video, resulting in one or more video analytics results; and
transmit one or more of the video analytics results to the remote device.

18. A method of performing video surveillance, the method comprising:
capturing a video from a location;
storing a location indicator representative of the location;
selecting one or more video analytics algorithms from a plurality of available video analytics algorithms based at least in part on the location indicator, wherein the selected one or more video analytics algorithms include less than all of the plurality of available video analytics algorithms;
performing the selected one or more video analytics algorithms on the captured video, resulting in one or more results; and
displaying at least some of the one or more results on a display.

19. The method of claim 18, wherein the video is captured by a mobile security device, and at least some of the selected one or more video analytics algorithms are performed by the mobile security device.

20. The method of claim 18, wherein the video is captured by a mobile security device, and the mobile security device is configured to transmit at least part of the captured video and the location indicator to a remote device, wherein at least some of the selected one or more video analytics algorithms are performed by the remote device.
